(19) United States
(12) Patent Application Publication
(10) Pub. No.: US 2002/0159477 A1
(43) Pub. Date: Oct. 31, 2002

(54) Enhanced crosspoint bus protocol

(75) Inventor: Charles L. Johnson, Taylorsville, UT (US)

Correspondence Address: Jack E. Haken, Corporate Patent Counsel, U.S. Philips Corporation, 580 White Plains Road, Tarrytown, NY, 10591, US

(73) Assignee: Koninklijke Philips Electronics N.V.

(21) Appl. No.: 09/796,184

(22) Filed: Feb. 28, 2001

(51) Int. Cl. H04L 12/403; H04L 12/42; H04J 3/16; H04J 3/22

(52) U.S. Cl. 370/466; 370/451

(57) ABSTRACT

An enhanced crosspoint bus control protocol is provided for expanding a conventional crosspoint bus by altering one or more bit definitions in a standard encoded bus control message. In accordance with one aspect of the present invention, by changing the definition of one or more predetermined bits in a message sequence such that these bits are control bits, the novel crosspoint bus control protocol preferably signifies whether the message corresponds to a standard crosspoint bus architecture or to an extended crosspoint bus architecture. The unique enhanced crosspoint bus protocol of the present invention supports an extended message length while being backward compatible with existing crosspoint bus protocols, thereby allowing the existing and enhanced crosspoint bus protocols to advantageously co-exist on the same physical bus.

### FIELD OF THE INVENTION

The present invention relates generally to bus control architectures, and more specifically relates to an enhanced crosspoint bus protocol.

### BACKGROUND OF THE INVENTION

Crosspoint bus architectures and controllers are well known in the art. For example, a conventional crosspoint bus implementation used for controlling routing switcher products was created as a command protocol of Philips Broadcast, and was first introduced in 1983 as the control system for the Philips TVS-2000 family of routing switchers. This conventional crosspoint bus protocol has evolved through several different routing switcher families. The most recent evolution is Super crosspoint bus, which is a 32-bit serial protocol implementation. The fundamental bit structure and/or definitions of this particular protocol, however, has remained significantly unchanged, thereby allowing all families of routing switcher products to co-exist on the same physical crosspoint bus.

While the present crosspoint bus has been adequate thus far, recent trends prescribe a need for additional special feature bits as well as expanded input and output range capability, etc., which conventional crosspoint bus protocol implementations do not allow. There is a need, therefore, in the field of bus control architectures, to provide a crosspoint bus control protocol that is capable of supporting an extended bus architecture. Moreover, the enhanced control protocol must be backward compatible with existing crosspoint bus protocols.

### SUMMARY OF THE INVENTION

An enhanced crosspoint bus control protocol is provided for expanding a conventional crosspoint bus by altering one or more bit definitions in a standard encoded control message.

In accordance with one aspect of the present invention, by changing the definition of one or more predetermined bits such that these bits are control bits, the novel crosspoint bus control protocol preferably signifies whether the message corresponds to a standard (i.e., conventional) crosspoint bus architecture or to an extended crosspoint bus architecture. The unique enhanced crosspoint bus protocol of the present invention supports an extended message length while being backward compatible with existing crosspoint bus protocols, thereby allowing the existing and enhanced crosspoint bus protocols to advantageously co-exist on the same physical bus.

In accordance with another aspect of the invention, a crosspoint bus control protocol is provided which supports an extended crosspoint bus by altering the definition of at least one bit in a sequence of crosspoint bus message data bits such that the at least one bit is a control bit.

In accordance with a further aspect of the invention, a second framing bit is added in the protocol for providing a mechanism to further extend the crosspoint bus in a similar manner, should subsequent bus expansion be necessary.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a logical state diagram for a crosspoint bus routing switcher matrix decoder, formed in accordance with one embodiment of the present invention.

FIG. 2 is a logical state diagram for a crosspoint bus controller, formed in accordance with one embodiment of the present invention.

FIG. 3 is a block diagram depicting an illustrative embodiment of a crosspoint bus controller defined by the logical state diagram shown in FIG. 2, in accordance with the present invention.

### DETAILED DESCRIPTION OF PREFERRED EMBODIMENTS

The present invention will be described below in the context of a crosspoint bus architecture. It is to be understood, however, that the present invention is not limited to this or any particular bus architecture or circuit configuration. Rather, the invention is more generally applicable to any suitable crosspoint bus architecture or circuit for providing an extended bus control protocol while maintaining backward compatibility with existing standard protocols, in accordance with the principles set forth herein.

In order to understand the general operation of a crosspoint bus, it is helpful to understand the fundamental operation of a routing switcher itself. A routing switcher typically comprises a plurality of matrix cards, which are operatively coupled to and control corresponding crosspoint switches. Crosspoint bus matrix cards generally do not include enough memory for storing or buffering incoming crosspoint bus messages and therefore a synchronous state machine included on each matrix card preferably keeps track of the present logical state of the card. The state machine decodes incoming crosspoint bus messages one bit at a time as they are received (i.e., “on-the-fly”).

A crosspoint bus protocol suitable for use in conjunction with the present invention is described in Appendix A. In essence, the crosspoint bus protocol described in Appendix A is a synchronous serial protocol comprising five differential signals, namely, RESET, DATA, CLOCK, TAKE, and CONFIRM. The RESET, DATA, CLOCK and TAKE signals are transmitted from a crosspoint bus controller to the matrix cards. The CONFIRM signal, on the other hand, is generated by the matrix cards and is returned to the crosspoint bus controller to acknowledge that a message was properly received by the matrix card and that the intended command will be executed. The decoding of a crosspoint bus message begins with the RESET signal being asserted (logic LOW state) and subsequently releasing (i.e., de-asserting) the RESET line to a logic HIGH state. This resets all state machines on all matrix cards to an IDLE state.

In the above-noted routing switcher system, all matrix cards concurrently receive the messages broadcast by the crosspoint bus controller. Therefore, in order to distinguish and target one or more individual matrix cards for receipt of a command, each routing switcher matrix card is typically programmed with an address uniquely identifying the card to the crosspoint bus controller. When an incoming crosspoint bus message is received by one or more matrix cards, each message data bit is evaluated or compared serially, one bit at a time, against an expected programming bit for that location in the crosspoint bus data sequence. The state machine included on each matrix card keeps track of the present state of the card. If the data bit matches the programming bit (i.e., both logic “zero” or both logic “one”), the state machine advances to evaluate the next bit. If the incoming crosspoint bus data bit does not match the programming bit, the state machine transitions to a “DO NOTHING” state, where it remains until the crosspoint bus controller initiates a RESET.

Table 1 below illustrates a sequence of bit definitions for a conventional crosspoint bus protocol (e.g., the previously-mentioned Super crosspoint bus protocol). With reference to Table 1, the conventional crosspoint bus protocol utilizes certain bit definitions that reside in fixed bit positions. The conventional protocol, for example, employs a framing bit, FRM, in the ninth position of the bit sequence, which is, by definition, required to be “zero” (i.e., logic LOW). Additional details regarding the other bit definitions may be found in Appendix A.

TABLE 1
32-Bit Crosspoint Bus Bit Definition

| 0 | 1 | 2 | 3 | 4 | 5 | 6 | 7 | 8 | 9 | 10 | 11 | 12 | 13 | 14 | 15 |
|---|---|---|---|---|---|---|---|---|---|---|---|---|---|---|---|
| S | M | O | O | O | O | O | O | F | L | L | L | L | L | L | L |
| V | E | H | H | T | T | T | T | R | 1 | 2 | 4 | 8 | 1 | 3 | 6 |
| T | M | A | B | A | B | C | D | M | | | | | | | 6 |
| 16 | 17 | 18 | 19 | 20 | 21 | 22 | 23 | 24 | 25 | 26 | 27 | 28 | 29 | 30 | 31 |
| I | I | I | I | I | I | R | S | O | O | O | O | I | I | I | I |
| H | H | T | T | T | T | E | V | U | U | U | U | U | U | U | U |
| 2 | 4 | A | B | C | D | V | O | A | B | C | D | A | B | C | D |

In one embodiment of the present invention, an enhanced crosspoint bus protocol utilizes a single control bit, preferably by altering the conventional FRM bit definition, to specify an extended bus protocol for each routing switcher control command that is transmitted. Specifically, when the FRM bit is a logic “one” (i.e., logic HIGH), the conventional 32-bit message length is extended to any predetermined length, preferably 48 bits. Since the standard protocol does not utilize the framing bit FRM to convey command data from the crosspoint bus controller, it is convenient to modify this bit definition for use as a control bit in the enhanced crosspoint bus protocol. However, it is to be appreciated that, in accordance with the present invention, the control bit for the enhanced crosspoint bus protocol may be defined to be any bit position, preferably one that is not presently allocated as a command bit by the conventional crosspoint bus control protocol, at least for backward compatibility purposes.

There may be other bits in a control bus message sequence that are defined, in accordance with a specific bus protocol, to be a predetermined (fixed) logic state in order for the message to be interpreted as valid by a crosspoint bus decoder. The present invention may similarly alter the definitions of any one or more of these predefined bits to be control bits for specifying an extended crosspoint bus architecture.

By way of example only, a routing switcher matrix card that is decoding an incoming message according to the conventional Super crosspoint bus protocol expects to find a logic “zero” in the ninth bit position. If this framing bit is not logic “zero,” the conventional crosspoint bus matrix card will enter a “DO NOTHING” state, as previously described herein above, and will preferably ignore the enhanced crosspoint bus command(s) subsequently transmitted. Similarly, a matrix card that is decoding an incoming crosspoint bus message in accordance with the enhanced crosspoint bus protocol of the present invention expects to identify a logic “one” in the ninth bit position of the message sequence. If this bit is not a logic “one,” the enhanced crosspoint bus matrix card will preferably ignore all shorter (e.g., 32-bit) Super crosspoint bus commands as employed by the conventional protocol.

The above-described redefinition of the framing bit allows substantially all other bits in the protocol to be operatively shifted at will, without adversely impacting compatibility with existing crosspoint bus routing switcher systems. Thus, matrix cards using the enhanced crosspoint bus protocol of the invention may operate interleaved with matrix cards using the standard control protocol on the same physical bus. This is an important and desirable aspect of the present invention.

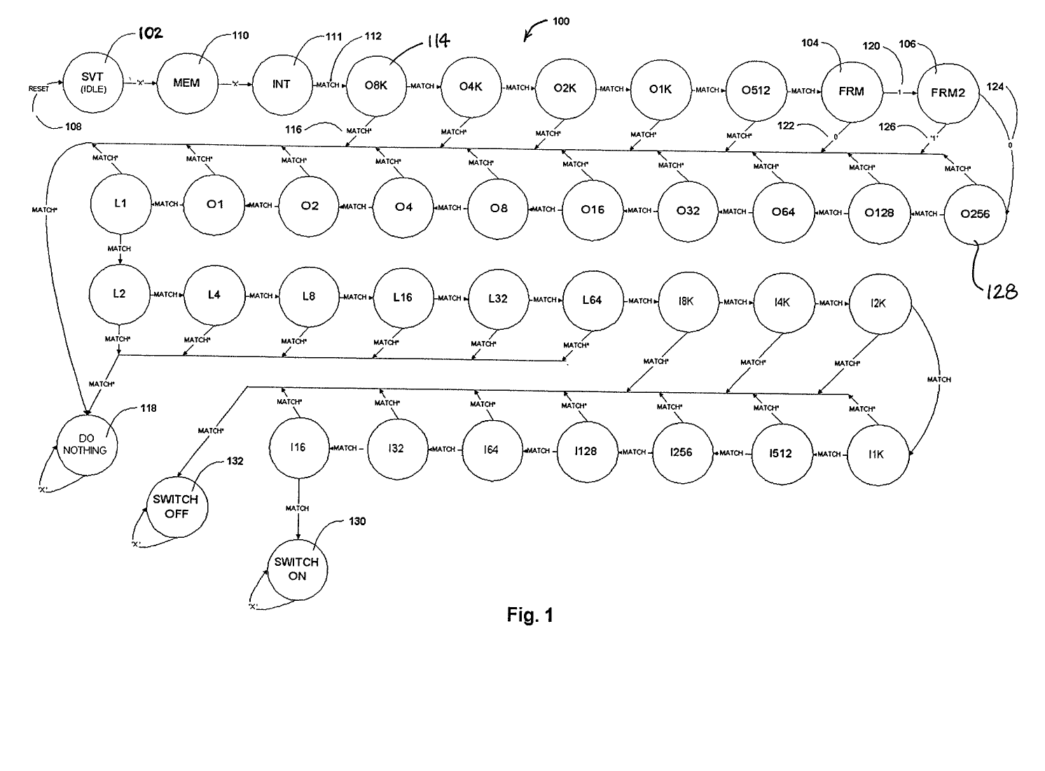

By way of example only, preferred bit designations for a 48-bit Ultra crosspoint bus protocol, in accordance with the present invention, are shown in Table 2 below. The Ultra crosspoint bus protocol is an illustrative embodiment of the enhanced crosspoint bus protocol described herein. In this preferred embodiment of the present invention, depicted by a logical state diagram 100 of FIG. 1, the Ultra crosspoint bus protocol preferably uses two framing bits, namely, FRM and FRM2 in the ninth and tenth bit positions, respectively. It is to be appreciated that after the first framing bit FRM (residing in the ninth bit position for backward compatibility) has specified an enhanced crosspoint bus protocol, essentially any subsequent bit definitions may be chosen. The allocation of the second framing bit FRM2 to the tenth bit position in the message sequence is, therefore, purely arbitrary.

TABLE 2
Ultra Crosspoint Bus Bit Definitions

| 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 |
|---|---|---|---|---|---|---|---|---|---|---|---|---|---|---|---|---|---|---|---|---|---|---|---|
| S | M | I | O | O | O | O | O | F | F | O | O | O | O | O | O | O | O | O | L | L | L | L | L |
| V | E | N | 8 | 4 | 2 | 1 | 5 | R | R | 2 | 1 | 6 | 3 | 1 | 8 | 4 | 2 | 1 | 1 | 2 | 4 | 8 | 1 |
| T | M | T | K | K | K | K | 1 | M | M | 5 | 2 | 4 | 2 | 6 | | | | | | | | | 6 |
| | | | | | | | 2 | | 2 | 6 | 8 | | | | | | | | | | | | |
| 24 | 25 | 26 | 27 | 28 | 29 | 30 | 31 | 32 | 33 | 34 | 35 | 36 | 37 | 38 | 39 | 40 | 41 | 42 | 43 | 44 | 45 | 46 | 47 |
| L | L | I | I | I | I | I | I | I | I | I | I | I | I | I | I | S | R | G | S | S | S | S | S |
| 3 | 6 | 8 | 4 | 2 | 1 | 5 | 2 | 1 | 6 | 3 | 1 | 8 | 4 | 2 | 1 | V | E | A | P | P | P | P | P |
| 2 | 4 | K | K | K | K | 1 | 5 | 2 | 4 | 2 | 6 | | | | | T | V | I | 1 | 2 | 3 | 4 | 5 |
| | | | | | | 2 | 6 | 8 | | | | | | | | | | N | | | | | |

The addition of a second framing bit in the control bus protocol advantageously allows support for further extending the crosspoint bus protocol, should such expanded capability be required. Basically, this added bit functions as a “hook” for future bus expansion. Extended crosspoint bus protocols may include additional “hooks” in the protocol, at various bit locations in the message, for successively extending the crosspoint bus protocol to a substantially unlimited length. Furthermore, in accordance with the present invention, any number of framing bits may be included in the enhanced crosspoint bus message sequence for specifying multiple crosspoint bus protocols. In this manner, a plurality of matrix cards employing various control protocols may co-exist on the same physical bus.

With continued reference to FIG. 1, the logical state diagram 100 for a preferred crosspoint bus decoder may be included in a crosspoint bus matrix card. By way of example only, the crosspoint bus decoder preferably initially starts in an IDLE state (not shown) and, after receiving a RESET signal 108, subsequently enters a SVT state 102. As shown in the example of FIG. 1, the first few states, namely, SVT (Salvo transfer) 102, MEM 110 and INT 111, may be used for executing previously stored “SALVO” commands, for “refresh” commands and “interrogate” commands, respectively. It is to be appreciated that the term “SALVO” as used herein is intended to refer to a mechanism for buffering multiple commands and executing them at a later time. In certain crosspoint bus control protocols, for example, a Salvo bit is sent with each “deferred” command, instructing the controller to defer execution of the corresponding command until a later time (e.g., when a Salvo transfer (SVT) is asserted).

The above-noted bits, namely, SVT, MEM and INT, are special bits which are preferably bypassed by the routing switcher matrix card decoder, since they are not regular switching commands but, rather, augment the behavior of the command. The “X” designation in FIG. 1, with particular reference to states SVT 102 and MEM 110, is intended to represent a “don't care” condition, which indicates that logical flow proceeds to a next state regardless of the value of the received input bit for the bit position being evaluated. A fourth state, O8K 114, along with subsequent logical states (e.g., O4K, O2K, O1K, O512, FRM, FRM2, O256, O128, O64, O32, O16, O8, O4, O2, O1, L1, L2, L4, L8, L16, L32, L64, I8K, I4K, I2K, I1K, I512, I256, I128, I64, I32, and I16), each involve a comparison of the incoming message data bit with an expected programming bit. Each of the above-noted logical states corresponds to a unique bit position in the input message sequence, as shown in Table 2.

As previously discussed, if a match is detected (as shown at 112) in any one state, the decoder preferably advances to a next state, except when the decoder is in a certain special state, in which case it simply stays in that state until detecting a RESET signal 108. For example, if no match is found (as shown at 116) when evaluating a bit position corresponding to state O8K 114, the decoder preferably enters either a “DO NOTHING” state 118 or, if the decoder is in any one of states I8K, I4K, I2K, I1K, I512, I256, I128, I64, I32 and I16, the decoder preferably enters a “SWITCH OFF” state 132, where it waits in either case until receiving a valid RESET signal 108. As noted above, the “X” designation in the state diagram of FIG. 1 indicates a “don't care” condition. In this case, logical flow proceeds regardless of the value of subsequent bits in the input bit sequence. Furthermore, it is to be appreciated that the designation “MATCH*” in FIG. 1 is intended to indicate that no match is detected for the particular bit position being evaluated.

With continued reference to FIG. 1, when the decoder is in state 104, preferably evaluating a first framing bit FRM, if a logic “zero” is detected (as shown at 122), the decoder preferably assumes that the message is employing a conventional crosspoint bus protocol, rather than the enhanced protocol, and will advance to the “DO NOTHING” state 118 where it ignores subsequent bus controller commands. If a logic “one” is detected (as shown at 120) for the FRM bit, specifying an enhanced crosspoint bus protocol, the decoder preferably advances to a next state 106 where a second framing bit FRM2 may then be evaluated.

In accordance with a preferred implementation of the Ultra crosspoint bus protocol of the present invention, the matrix card decoder expects the second framing bit FRM2 to be logic “zero.” Therefore, once in state 106, if the decoder identifies that the FRM2 bit is a logic “one” (as shown at 126), it will preferably advance to the “DO NOTHING” state 118 where it ignores subsequent message bits. Again, if a logic “zero” is detected (as shown at 124) for the FRM2 bit, thus indicating a match, the decoder preferably advances to a next logic state 128, in this case evaluating bit O256, and proceeding until either no match (i.e., MATCH*) is detected, or until a valid crosspoint bus command is interpreted for switching a particular crosspoint switch on (i.e., a “SWITCH ON” state 130) or off (i.e., a “SWITCH OFF” state 132). Once in the “SWITCH ON” state 130 or “SWITCH OFF” state 132, the matrix card simply ignores further message bits (as represented by “X”) until receiving a RESET signal 108. It is to be appreciated that the bit definition for the second framing bit FRM2, as set forth herein, may also be changed in accordance with the present invention so that a logic “one” instead specifies the enhanced crosspoint bus protocol and thereby advances the state of the decoder in a similar fashion.

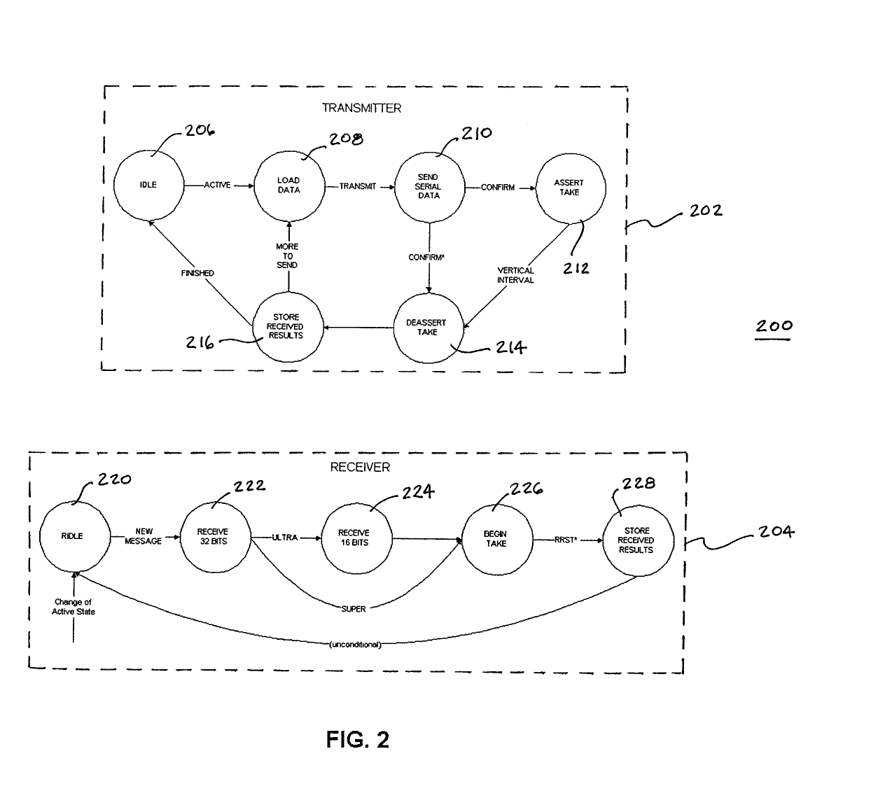

FIG. 2 illustrates a logical state diagram for an exemplary implementation of a crosspoint bus controller for implementing an enhanced crosspoint bus protocol (e.g., Ultra crosspoint bus) of the present invention. As shown in FIG. 2, the crosspoint bus controller 200 suitable for use with the invention preferably includes two sections, namely, a transmitter section 202 and a receiver section 204. When the controller is active (e.g., following an IDLE state), the transmitter section 202 preferably loads data in state 208 from an external source, such as, for example, a dual-port random access memory (DPRAM), a first-in-first-out (FIFO) register, parallel buffer, or other suitable equivalent. The external data is preferably organized in the following bit sequence: Output number (e.g., Oᵢ), Level number (e.g., Lⱼ), Input number (e.g., Iₖ) and Control bits. The transmitter section 202 reorganizes this data into a proper sequence, for example as described above, and sends the data out serially 210 on the crosspoint bus (not shown). Connection with the crosspoint bus may be made in any conventional manner, such as, for example, by a wireless or wired communication channel.

After generating the serial data stream, the transmitter section 202 of the controller preferably receives back a CONFIRM bit and generates a TAKE pulse in state 212 in response thereto. Upon completion of a command in state 214, the transmitter section 202 preferably checks to see if there are more commands to send as indicated in state 216. When no further commands remain in the external buffer, the transmitter section 202 returns to the IDLE state 206 and waits for a command to begin transmitting again.

With continued reference to FIG. 2, the receiver section 204 of the crosspoint bus controller 200 is preferably used when the controller is in a standby mode of operation, that is, when the controller 200 is monitoring the crosspoint bus but is not transmitting any data. For example, this may be a diagnostic mode, or more commonly a redundant mode, where one unit is an active transmitting unit and another is operational in a “hot” standby mode, ready to take over control at any moment when necessary (e.g., when a failure is detected). When active (e.g., following a receiver idle (RIDLE) state 220), the receiver section 204 acts in a manner consistent with a universal asynchronous receiver/transmitter (UART), finding the beginning of each command and decoding a serial data stream. After each command is properly received, the command is preferably stored as indicated in state 228 in external memory (e.g., DPRAM or FIFO). In this mode, the standby unit preferably keeps track of the operation of the active unit and can evaluate its performance.

Since the receiver section 204 is receiving messages “blind,” it does not know a priori what protocol is being used. It receives 32 bits in state 222 and then evaluates the FRM and FRM2 bits to determine if another 16 bits are expected. If the FRM and FRM2 bits indicate that enhanced (Ultra) crosspoint bus protocol is being used, the receive section 204 receives another 16 bits in state 224 (“RECEIVE 16 BITS”) and subsequently enters a “BEGIN TAKE” state 226. Alternatively, if the FRM and FRM2 bits indicate that a conventional crosspoint bus (e.g., Super crosspoint bus) protocol is being used, the receiver section 204 simply enters the “BEGIN TAKE” state 226, bypassing state 224. After a received command has been evaluated and stored, the receiver section 204 preferably returns to the RIDLE state 220.

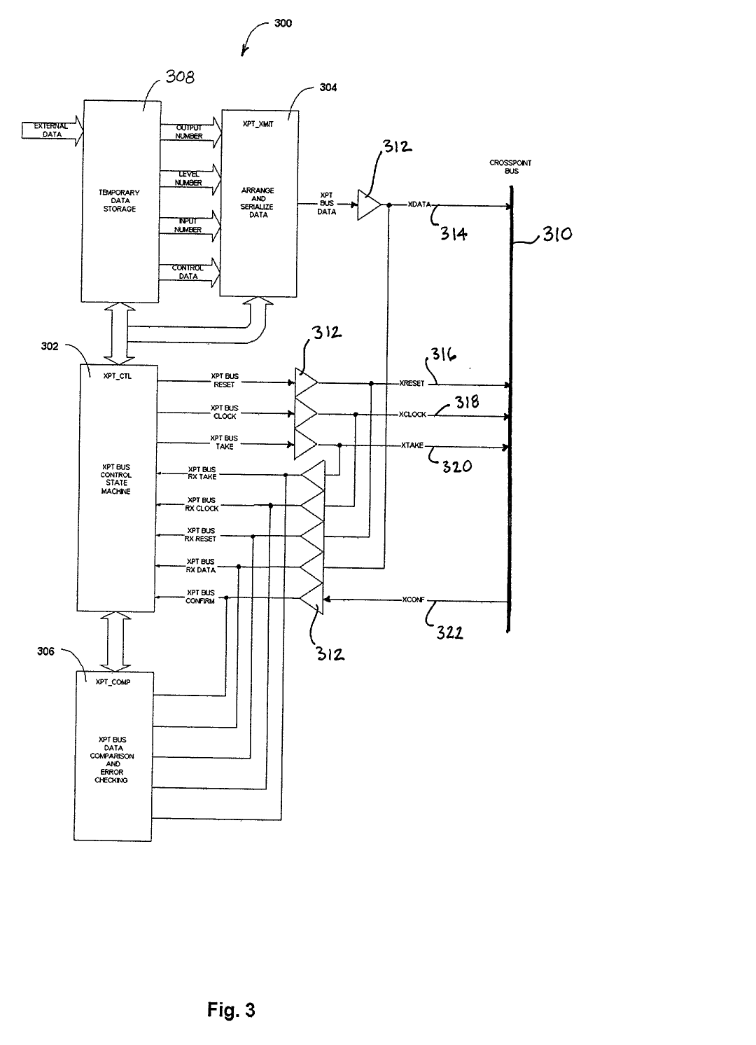

FIG. 3 illustrates a preferred circuit 300 for implementing a crosspoint bus controller having the logical state diagram of FIG. 2. It is to be appreciated that the circuit depicted in FIG. 3 is merely illustrative, and that any suitable equivalent controller may be employed with the present invention. With reference to FIG. 3, a control logic block XPT_CTL 302 preferably generates various control and timing signals used throughout the controller 300 in accordance with the enhanced crosspoint bus protocol of the invention. For example, XPT_CTL 302 preferably operates circuitry (e.g., shift register) within a transmit block XPT_XMT 304 to operatively output command data XDATA 314 from the crosspoint bus controller to the crosspoint bus 310.

The output of the XPT_CTL control block 302 is preferably operatively coupled to a transmit block XPT_XMT 304. The XPT_XMT block 304 preferably organizes the controller message data, which may be received from a temporary data storage block 308 operatively coupled to the XPT_XMT block, in the proper bit sequence and serially outputs the message, including any framing bits. Block 308 preferably comprises a bank of registers (not shown), which may be implemented as a plurality of flip-flops or a suitable equivalent thereof, for providing at least temporary data storage. The data to be serially transmitted is preferably obtained from a series of multiplexers (not shown) which are preferably included in the transmit block 304, although any equivalent arrangement for serially outputting this data is contemplated by the present invention. Additionally, the serial data output from the XPT_XMT block 304 may be coupled to a buffer 312 for buffering the data XDATA 314 prior to being sent over the crosspoint bus 310.

In addition to the above-noted signals, the XPT_CTL block 302 preferably generates other crosspoint bus control signals, including a reset signal XRESET 316, a clock signal XCLOCK 318 and a “TAKE” signal XTAKE 320, each of which may be similarly coupled to a corresponding buffer 312. The XPT_CTL block 302 also preferably receives and is responsive to several signals from the crosspoint bus, such as, RX TAKE, RX CLOCK, RX RESET, RX DATA and CONFIRM. These signals, namely, RESET, DATA, CLOCK, TAKE and CONFIRM are described in further detail in Appendix A.

With continued reference to the illustrative embodiment of FIG. 3, the controller circuit 300 preferably includes a compare block XPT_COMP 306 operatively coupled to the XPT_CTL block 302 which provides error detection and/or correction capability, among other important features. The XPT_COMP block 306 preferably runs in a redundant mode of operation. Error detection and/or correction schemes suitable for use with the present invention are well known by those skilled in the art and will therefore not be described in detail herein.

In accordance with another embodiment of the present invention, a generic routing switcher matrix card or module is preferably constructed so that both conventional crosspoint bus (e.g., Super crosspoint bus) protocol commands and enhanced crosspoint bus (e.g., Ultra crosspoint bus) protocol commands are decoded. Preferably, a control bit such as, for example, framing bit FRM or a similar parameter bit, steers the incoming message to appropriate decoding circuitry for further evaluation. For this generic module, the protocol must be specified, or a default protocol may be employed if such designation has not been provided. The use of a single generic matrix card in a routing switcher system has many advantages, including ease of manufacturing and repair, since only one matrix board type is required for both crosspoint bus control protocols.

The present invention as described herein may be implemented, at least in part, by one or more application programs. Such application programs, or software components thereof, including instructions or code for performing the methodologies of the invention, may be stored in one or more storage media (e.g., read only memory (ROM), fixed or removable storage, etc.) and, when ready to be executed, loaded in whole or in part (e.g., into random access memory (RAM)) and executed by a processor (not shown). It is to be appreciated that the term “processor” as used herein is intended to include any processing device, such as, for example, one that includes a central processing unit (CPU) and/or other processing circuitry (e.g., microprocessor). Additionally, it is to be understood that the term “processor” may refer to more than one processing device, and that various elements associated with a processing device may be shared by other processing devices.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

### APPENDIX A:

### CROSSPOINT BUS-THEORY AND DESCRIPTION

Introduction

Crosspoint Bus is a command protocol of Philips Broadcast Television Systems Company (BTS) which is used for control of BTS routing switcher products. The purpose of this document is to describe the operation of those signals as they relate to routing switcher control.

History

Crosspoint Bus first appeared in 1983 as the control system for the TVS-2000 family of routing switcher. The protocol for Crosspoint Bus has evolved through several different routing switcher families, but without changing the basic bit structure, which allows all families of routing switcher products to co-exist on the same Crosspoint Bus.

Theory of Operation

In order to understand the operation of Crosspoint Bus, it is necessary to understand the operation of the routing switcher itself, since this is the function of Crosspoint Bus. The TVS-2000 and TVS-3000 routing switchers were based on a 10 by 10 matrix card, and used a BCD (Binary Coded Decimal) protocol. The MARS routing switcher family uses an Octal (base 8) encoding scheme. The VENUS family of routing switchers use a true binary encoding scheme. Regardless of the encoding protocol, each matrix card in a routing switcher system contains a synchronous state machine which decodes the incoming Crosspoint Bus messages one bit at a time as they are received. The implementation of this state machine has varied over the years, starting with a PROM based architecture in the TVS-2000 family, migrating to a PAL based architecture in the TVS-3000 family. The MARS and VENUS families currently use FPGAs to create the state machine. Whichever method has been used, the net result of decoding Crosspoint Bus is the same.

Crosspoint Bus is a synchronous serial protocol consisting of five differential signals, namely RESET, DATA, CLOCK, TAKE, and CONFIRM. In the following discussion, these signals will be described in terms of HIGH and LOW as reflected by the positive (+) side of each differential pair. The RESET, DATA, CLOCK, and TAKE signals travel from the Crosspoint Bus controller to the matrix cards. The CONFIRM signal is generated by matrix cards and returns to the Crosspoint Bus controller.

The decoding of a Crosspoint Bus message begins with the RESET signal being asserted (LOW) and then releasing the RESET to a HIGH state. This resets all state machines on all matrix cards to their idle state, prior to receiving data on the DATA signal line. Following the release of the RESET line, 32 clock pulses are sent out on the CLOCK line. The data on the DATA line is changed synchronously with the CLOCK, such that the state of each DATA bit is sampled on the LOW-to-HIGH transition of each CLOCK bit. One Crosspoint Bus command can, and usually does, affect many matrix cards in a routing switcher system. The ultimate goal of a Crosspoint Bus command is to cause a crosspoint to switch on. As a consequence of this action, whatever crosspoint(s) is (are) switched on (for that output) prior to the Crosspoint Bus command need to switch off. All of this happens simultaneously with a single Crosspoint Bus command. Refer to Table 1 for a definition of the bits in the following description. Bits are transmitted in the order shown (left-to-right).

Since the first two protocols are no longer supported, and the only major difference between Super Crosspoint Bus and Super Binary Crosspoint Bus is whether the data is BCD or Hexadecimal, this description will focus on the most complex and most common protocol, Super Binary Crosspoint Bus. A discussion about the BCD and Octal modes may be found at the end of this document.

The ‘SVT’ bit is used to execute any previously stored SALVO commands. Not all routing switchers support the SALVO function. The description of how the SVT bit functions will be deferred until the discussion of the SVO (Salvo) bit later in this document.

The ‘M’ bit is set whenever the command is a “refresh” rather than a regular switch command. All routing switcher outputs are refreshed periodically to restore any crosspoints which may have been dropped by a power failure or board swap. Crosspoint Bus matrix cards do not have any on board memory to retain crosspoint settings. All crosspoint selections are latched on each matrix card, and are static. They do not require any periodic refresh. However, since no non-volatile memory exists on the matrix cards, it is good system practice to send refresh commands to restore any crosspoint which may have been lost. The system refresh cycle time is determined by control system performance and by the tolerance level of the installed application. The ‘M’ bit is ignored by routing switcher matrix cards. Their operation is the same whether or not the ‘M’ bit is set. This bit is reserved in the protocol as a bookkeeping function so that failures in commands and refreshes may be handled differently by the control system.

The next six bits (OHA, OHB, OTA, OTB, OTC, and OTD) are the six most significant bits of the output number. Historically, data was sent in BCD format and least significant bit first in each digit group. This is the reason for the scrambled nature of these bits. In the Super Binary mode, these six bits may be treated as a 6 bit binary number, but must be scrambled as shown. The remaining four output bits are found at the end of the Crosspoint Bus command. The purpose of this “split” is to define which matrix card is to be switched early in the command, and the actual output number (on that card) defined later in the command. Each routing switcher matrix card is programmed with a unique address consisting of three parts (using switches or jumpers). The OUTPUT (these six bits) is the first part of that programming with the LEVEL bits and INPUT bits being the other two parts. As each Crosspoint Bus bit is received by each matrix card, it is compared against each programming bit for that bit location in the Crosspoint Bus data. If the data bit matches the programming bit, (both ZERO or both ONE) the state machine continues to the next bit. If the incoming Crosspoint Bus data bit does not match the corresponding programming bit, the state machine transitions to the DO NOTHING state where it remains until the next Crosspoint Bus RESET, which returns the state machine to the idle state, ready to receive a new command. While in the DO NOTHING state, all subsequent Crosspoint Bus data bits are ignored. Because the data did not match the programming, the matrix card knows that the incoming command is not for him, and ignores it.

The next eight bits (FR, V, A, S3, S4, S5, S6, and S7) are the LEVEL bits. The FR (framing bit) is always ZERO. The BTS implementation of the Crosspoint Bus control hardware stores the Crosspoint Bus command in four bytes of memory, and uses a byte of FF (hex) as a terminator (last command). Because of this, no byte is allowed to be an FF. The FR bit guarantees that this “byte” always contains at least one ZERO. With the change to Super Binary Crosspoint Bus, this rule had to be relaxed to allow the last byte (OU and IU) to be FF, since this is now a valid code. The other three bytes must still be something other than FF. The names of the other bits date back to earlier implementations where ‘V’ meant “video” and ‘A’ meant “audio”. Bits S3 through S7 were other switcher levels. In the Super Binary Crosspoint Bus implementation, these seven bits form a 7 bit binary representation of the routing switcher LEVEL (‘V’ is the least significant bit). Level 00 is not used, nor is level 127. Level 00 has a special meaning in conjunction with the SVT Salvo Transfer command. Each of these eight bits are compared with their corresponding programming in a manner identical to that described in the OUTPUT section above. If each data bit matches it's programming bit, the state machine continues to the next bit. If the incoming Crosspoint Bus data bit does not match the corresponding programming bit, the state machine transitions to the DO NOTHING state. The OUTPUT and LEVEL bits are defined separately, but in reality can be considered to be a single 13-bit address specifying the output (and level) to be switched. If the state machine gets through the first sixteen data bits without a mismatch between data and programming (DO NOTHING bit not set), the incoming Crosspoint Bus command does concern this matrix card, and the remaining bits specify which output will be switched, and whether to switch ON of OFF. If this is a switch ON command, the input is also specified.

The next six bits (IHA, IHB, ITA, ITB, ITC, and ITD) are the six most significant bits of the input number. Historically, data was sent in BCD format and least significant bit first in each digit group. This is the reason for the scrambled nature of these bits. In the Super Binary mode, these six bits may be treated as a 6 bit binary number, but must be scrambled as shown. The remaining four input bits are found at the end of the Crosspoint Bus command. As each Crosspoint Bus bit is received by each matrix card, it is compared against it's programming. If the data bit matches the programming bit, (both ZERO or both ONE) the state machine continues to the next bit. If an incoming Crosspoint Bus data bit does not match its programming bit, the state machine transitions to the SWITCH OFF state. Once in the SWITCH OFF state, all subsequent Crosspoint Bus data bits are ignored. Because the data did not match the programming, the matrix card knows that the incoming command concerns one of his outputs, but not one of his inputs. This matrix card must then determine the proper output units digit and switch it off. It is the responsibility of some other matrix card to switch some input on. The matrix card which is to switch on returns the CONFIRM signal to the control system at this point. The CONFIRM bit is simply a change in signal level, and contains no data. The purpose of the CONFIRM bit is to tell the control system that the matrix card containing the requested output and input exists and has correctly decoded the command to this point. It does NOT guarantee that the requested crosspoint has actually been switched.

The REV or “Reverse” bit is valid only on Venus Analog Stereo Audio matrix cards. When set, the input from the “other” level is switched to this output/level. This can be used to create left-right channel swaps, feed both left and right outputs from a mono source, or do a left+right additive mix. In this last case (L+R), the IHB bit is “borrowed” from its normal function to become a gain control bit. When doing a L+R mix, the IHB bit should be set, which causes a 6 db gain reduction to compensate for the change in signal level caused by the mix. This bit is ignored by other models of matrix card.

The SVO bit is the SALVO Command bit for each bit. As mentioned earlier, the SALVO function is implemented only on some types of matrix card. On cards without the SALVO capability, this bit has no function and is ignored. Where supported, the matrix cards have double buffering incorporated into the latching hardware for each output. When the SVO bit is not set, the specified switch is executed immediately. When the SVO bit is set, the current input is frozen, and the new source is pre-loaded into a secondary latch on the matrix card. This pre-loaded selection is held until an SVT (Salvo Transfer) command is received.

Note that blocking circuitry on the matrix card prevents any subsequent command, (either SALVO or normal), from propagating to the requested output once an SVO containing command has been sent, until after an SVT command is sent.

The SVT (Salvo Transfer) command is global in nature, and affects ALL outputs and levels of the entire routing switcher matrix simultaneously. A Salvo Transfer command sets only the SVT bit leaving all other bits set to zero. When received by matrix cards, any and all pending SALVO switches are executed, causing the previously transmitted SALVO commands to become effective.

The OUTPUT units and INPUT units are the final eight bits of the Crosspoint Bus command. The OUTPUT bits (OUA, OUB, OUC, and OUD) The INPUT bits (IUA, IUB, IUC, and IUD)

TABLE 1
STANDARD CROSSPOINT BUS PROTOCOL
(originally used on TVS-1000 switcher-no longer supported)

| S | V | A | M | O | O | O | O | I | I | I | I | S | S | S | S |
|---|---|---|---|---|---|---|---|---|---|---|---|---|---|---|---|
| | | | | T | T | T | T | T | T | T | T | P | P | P | P |
| | | | | A | B | C | D | A | B | C | D | | | | |
| S | S | S | S | S | S | S | S | O | O | O | O | I | I | I | I |
| P | P | P | P | P | P | P | P | U | U | U | U | U | U | U | U |
| | | | | | | | | A | B | C | D | A | B | C | D |

9/30 EXTENDED CROSSPOINT BUS PROTOCOL
(originally used on TVS-2000 switcher-no longer supported)

| S | V | A | M | O | O | O | O | F | S | S | S | S | S | I | I |
|---|---|---|---|---|---|---|---|---|---|---|---|---|---|---|---|
| | | | | T | T | T | T | R | 3 | 4 | 5 | 6 | 7 | H | H |
| | | | | A | B | C | D | | | | | | | A | B |
| I | I | I | I | S | S | S | S | O | O | O | O | I | I | I | I |
| T | T | T | T | P | P | P | P | U | U | U | U | U | U | U | U |
| A | B | C | D | 1 | 2 | 3 | 4 | A | B | C | D | A | B | C | D |

SUPER CROSSPOINT BUS PROTOCOL

| S | M | O | O | O | O | O | O | F | V | A | S | S | S | S | S |
|---|---|---|---|---|---|---|---|---|---|---|---|---|---|---|---|
| V | | H | H | T | T | T | T | R | | | 3 | 4 | 5 | 6 | 7 |
| T | | A | B | A | B | C | D | | | | | | | | |
| I | I | I | I | I | I | S | S | O | O | O | O | I | I | I | I |
| H | H | T | T | T | T | P | V | U | U | U | U | U | U | U | U |
| A | B | A | B | C | D | I | O | A | B | C | D | A | B | C | D |

SUPER BINARY CROSSPOINT BUS PROTOCOL (SBCBP)

| S | M | O | O | O | O | O | O | F | V | A | S | S | S | S | S |
|---|---|---|---|---|---|---|---|---|---|---|---|---|---|---|---|
| V | | H | H | T | T | T | T | R | | | 3 | 4 | 5 | 6 | 7 |
| T | | A | B | A | B | C | D | | | | | | | | |
| I | I | I | T | I | I | R | S | O | O | O | O | I | I | I | I |
| H | H | T | T | T | T | E | V | U | U | U | U | U | U | U | U |
| A | B | A | B | C | D | V | O | A | B | C | D | A | B | C | D |
| | * | | | | | | | | | | | | | | |

S=Status Request (Always 0)

SVT=Salvo Transfer Command Bit

V=Video Command Bit

A=Audio Command Bit

M=Memory Reply (Refresh)

OTx=Output Tens Digit A is LSB, D is MSB (BCD)-HEX on SBCBP

OHx=Output Hundreds Digit-A is LSB, D is MSB (BCD)-HEX on SBCBP

OUx=Output Units Digit-A is LSB, D is MSB (BCD)-HEX on SBCBP

FR=Framing Bit-0=Switcher Command, 1=Encoded Command

S3-7=Switcher Bits 3 through 7 (Bit per switcher, or Encoded (see FR))

Hx=Input Hundreds Digit-A is LSB, D is MSB (BCD)-HEX on SBCBP

ITx=Input Tens Digit-A is LSB, D is MSB (BCD)-HEX on SBCBP

IUx=Input Units Digit-A is LSB, D is MSB (BCD)-HEX on SBCBP

SPx=Spare Bits-Always 0

REV=Audio Reverse on VENUS Analog Stereo Audio-=0 on all other switchers

SVO=Salvo Switch Command Bit

IHB=GAIN control on VENUS Analog Stereo Audio (L +R: −6 db)

POSSIBLE DATA BIT LOCATIONS FOR NEXT GENERATION

| L | LOW | | | | | | M | L | HIGH | | | | | | M |
|---|---|---|---|---|---|---|---|---|---|---|---|---|---|---|---|
| S | | | | | | | S | S | | | | | | | S |
| B | | | | | | | B | B | | | | | | | B |
| V | A | S | S | S | S | S | F | S | M | R | S | S | A | V | V |
| | | 3 | 4 | 5 | 6 | 7 | R | V | | E | V | P | T | I | I |
| | | | | | | | | T | | V | O | | | X | S |
| O | O | O | O | O | O | O | O | O | O | S | S | S | S | S | S |
| U | U | U | U | T | T | T | T | H | H | P | P | P | P | P | P |
| A | B | C | D | A | B | C | D | A | B | | | | | | |
| I | I | I | I | I | I | I | I | I | I | S | S | S | S | S | S |
| U | U | U | U | T | T | T | T | H | H | P | P | P | P | P | P |
| A | B | C | D | A | B | C | D | A | B | | | | | | |

Control Bits

SVT

M

SVO

REV

SYNC

VIX

AT

SP

(GAIN)

OUTGOING BIT ORDER

| | S | M | O | O | O | O | O | O | F | V | A | S | S | S | S | S |
|---|---|---|---|---|---|---|---|---|---|---|---|---|---|---|---|---|
| | V | | H | H | T | T | T | T | R | | | 3 | 4 | 5 | 6 | 7 |
| | T | | A | B | A | B | C | D | | | | | | | | |
| BYTE | 0 | 0 | 1 | 1 | 1 | 1 | 1 | 1 | 0 | 0 | 0 | 0 | 0 | 0 | 0 | 0 |
| BIT | 8 | 9 | 8 | 9 | 4 | 5 | 6 | 7 | 7 | 0 | 1 | 2 | 3 | 4 | 5 | 6 |
| | I | I | I | I | I | I | R | S | O | O | O | O | I | I | I | I |
| | H | H | T | T | T | T | E | V | U | U | U | U | U | U | U | U |
| | A | B | A | B | C | D | V | O | A | B | C | D | A | B | C | D |
| BYTE | 2 | 2 | 2 | 2 | 2 | 2 | 0 | 0 | 1 | 1 | 1 | 1 | 2 | 2 | 2 | 2 |
| BIT | 8 | 9 | 4 | 5 | 6 | 7 | A | B | 0 | 1 | 2 | 3 | 0 | 1 | 2 | 3 |

What is claimed is:

1. A method of extending a standard crosspoint bus protocol for controlling an enhanced crosspoint bus, the method comprising the step of:
modifying a definition of one or more bits in a message sequence from a first predefined designation specifying the standard crosspoint bus protocol to a second predefined designation, the second designation being a control definition for specifying one of an enhanced crosspoint bus protocol and the standard crosspoint bus protocol;
wherein the enhanced crosspoint bus protocol is an expansion of the standard crosspoint bus protocol and is backward compatible with the standard protocol.

2. The method of claim 1, further comprising the step of:
adding at least one reserved bit definition in the enhanced crosspoint bus protocol, the at least one reserved bit definition being used to specify an expansion of the enhanced crosspoint bus protocol, the expanded enhanced crosspoint bus protocol being backward compatible with the enhanced and standard crosspoint bus protocols.

3. The method of claim 1, wherein the standard crosspoint bus protocol is a 32-bit serial protocol and the enhanced crosspoint bus protocol is a n-bit serial protocol, where n is greater than 32.

4. The method of claim 3, wherein n is equal to 48.

5. The method of claim 1, wherein the standard crosspoint bus protocol is a Super crosspoint bus protocol.

6. The method of claim 1, wherein the enhanced crosspoint bus protocol is an Ultra crosspoint bus protocol.

7. Apparatus for extending a standard crosspoint bus protocol for controlling an enhanced crosspoint bus, the apparatus comprising:
a controller operative to modify a definition of one or more bits in a message sequence from a first predefined designation specifying the standard crosspoint bus protocol to a second predefined designation, the second designation being a control definition for specifying one of an enhanced crosspoint bus protocol and the standard crosspoint bus protocol;
wherein the enhanced crosspoint bus protocol is an expansion of the standard crosspoint bus protocol and is backward compatible with the standard protocol.

8. The apparatus of claim 7, wherein the controller is further operative to add at least one reserved bit definition in the enhanced crosspoint bus protocol, the at least one reserved bit definition being used to specify an expansion of the enhanced crosspoint bus protocol, the expanded enhanced crosspoint bus protocol being backward compatible with the enhanced and standard crosspoint bus protocols.

9. The apparatus of claim 7, wherein the standard crosspoint bus protocol is a 32-bit serial protocol and the enhanced crosspoint bus protocol is a n-bit serial protocol, where n is greater than 32.

10. The apparatus of claim 7, wherein n is equal to 48.

11. The apparatus of claim 7, wherein the standard protocol is a Super crosspoint bus protocol.

12. The apparatus of claim 7, wherein the enhanced crosspoint bus protocol is an Ultra crosspoint bus protocol.

13. A routing switcher matrix circuit for selectively controlling a corresponding crosspoint switch in a routing switcher system, the routing switcher matrix circuit comprising:
a storage register operatively coupled to a serial data stream, the storage register at least temporarily storing data received from the serial data stream; and
a controller operatively coupled to the storage register and including a comparator for comparing each data bit in the serial data stream with a predetermined expected value, the controller being responsive to one or more bits in the data stream and selectively operating in at least one of a first mode and a second mode in response thereto, wherein in the first mode a first crosspoint bus protocol is used and in the second mode a second crosspoint bus protocol is used.

14. The circuit of claim 13, wherein the first crosspoint bus protocol is a 32-bit serial protocol and the second crosspoint bus protocol is a n-bit serial protocol, wherein n is greater than 32.

15. The circuit of claim 14, wherein n is equal to 48.

16. The circuit of claim 13, wherein the first crosspoint bus protocol is a Super crosspoint bus protocol and the second crosspoint bus protocol is an Ultra crosspoint bus protocol.

17. The circuit of claim 13, wherein the second crosspoint bus protocol is backward compatible with the first crosspoint bus protocol.

18. An article of manufacture for extending a standard crosspoint bus protocol for controlling an enhanced crosspoint bus, the article comprising a machine readable medium containing one or more programs which when executed implement the steps of:
modifying a definition of one or more bits in a message sequence from a first predefined designation specifying the standard crosspoint bus protocol to a second predefined designation, the second designation being a control definition for specifying one of an enhanced crosspoint bus protocol and the standard crosspoint bus protocol;
wherein the enhanced crosspoint bus protocol is an expansion of the standard crosspoint bus protocol and is backward compatible with the standard protocol.

19. The article of claim 18, wherein the one or more programs further implement the step of adding at least one reserved bit definition in the enhanced crosspoint bus protocol, the at least one reserved bit definition being used to specify an expansion of the enhanced crosspoint bus protocol, the expanded enhanced crosspoint bus protocol being backward compatible with the enhanced and standard crosspoint bus protocols.

20. The article of claim 18, wherein the standard crosspoint bus protocol is a 32-bit serial protocol and the enhanced crosspoint bus protocol is a n-bit serial protocol, where n is greater than 32.
